(19) United States
(12) Patent Application Publication
(10) Pub. No.: US 2005/0235875 A1
(43) Pub. Date: Oct. 27, 2005

(54) Lightweight aggregate binder formulation

(76) Inventor: Jim Dinakis, Victoria (AU)

Correspondence Address: VENABLE LLP, P.O. BOX 34385, WASHINGTON, DC, 20045-9998, US

(21) Appl. No.: 10/399,873

(22) PCT Filed: Oct. 22, 2001
(86) PCT No.: PCT/AU01/01351

§ 371 Date: Apr. 18, 2005

(30) Foreign Application Priority Data
Oct. 24, 2000 (AU) PR 0992

(51) Int. Cl. C08K 5/00

(52) U.S. Cl. 106/499

(57) ABSTRACT

The invention relates to a thermally stable composition, and methods for the preparation thereof, for use in the manufacture of a lightweight aggregate including a continuous bituminous phase, a discontinuous aqueous phase, an anionic oxide suspended in the discontinuous aqueous phase and at least one emulsifying agent. The anionic oxide may be a naturally occurring metal oxide having a needle-like crystal structure such as red oxide (CuO) or yellow oxide. The continuous bituminous phase may be for example grade 170 bitumen or crude oil, hydrocarbons or mixtures thereof. The emulsifying agent may be a clay emulsifier such as sodium bentonite, or a hydrous aluminium silicose or montmorillonite clay. The invention also relates to lightweight aggregate particles coated with such compositions and building materials formed from the lightweight aggregate in combination with a cementitious material.

### TECHNICAL FIELD

The present invention relates to aggregate suitable for use in lightweight concrete, and to lightweight concrete including the aggregate.

### BACKGROUND ART

The preparation of low density concrete by the incorporation of lightweight aggregates such as vermiculite, cork, slag, asbestos, bagasses and the like in a hydraulic binder such as a cement/sand/water mixture is well known. Low density concrete having much improved properties may be prepared by the incorporation of lightweight aggregate, in particular, foam particles such as polystyrene, into the binder.

However, cementitious materials do not readily bond with these lightweight aggregates, which are generally highly hydrophobic. The hydrophobic character and low density of polystyrene beads produces a tendency to float to the surface of the concrete as it sets. To overcome this problem, various bonding agents have been used to facilitate the incorporation of polystyrene foam particles into lightweight aggregates. These agents include bituminous products, coal tars and mixtures of pitch with epoxy resins or phenolic resins. The use of such bonding agents has proved problematic because coating of the polystyrene particles results in a tacky surface causing the particles to coalesce into a mass which is difficult to disperse in the cementitious matrix. Further, the coatings generally retain a strong bituminous odour which remains unacceptably detectable in the end product. More importantly, the bonding strength between the foam particles and the other components in the cured cement has not been ideal, resulting in an inferior product.

Applicant's earlier patent AU670754 (see also corresponding U.S. Pat. No. 5,472,498) the contents of which are incorporated herein by reference) provided a major advance in the art. By treating polystyrene foam particles with a bonding agent consisting of an emulsion comprising a discontinuous bituminous phase, and a continuous aqueous phase and having ferric oxide suspended in the aqueous phase. The use of this emulsion avoided the problems of surface tackiness and aggregation, provided a lightweight aggregate which was uniformly dispersible in concrete, and strongly bonded therewith providing a lightweight concrete of substantially improved strength. The ferric metal ions kept the lightweight aggregate in suspension in the wet concrete, preventing the aggregate particles from floating to the top, and also led to a strong bond between the aggregate and the concrete in the cured mixture providing a lightweight concrete of improved strength.

Prior to application to the lightweight particles, it was usual for the emulsion described in AU670754 to be diluted with water in compliance with specified concentrations. Failure to adhere to the specified concentration range would lead to a deterioration in the performance of the final product. The previous coating agent typically required addition of around 1 part of the emulsion to 2 parts water prior to application. Attempts by users to extend the emulsion by adding more water, contrary to product specifications, could result in an inferior concrete product.

Any discussion of the prior art throughout the specification should in no way be considered as an admission that such prior art is widely known or forms part of common general knowledge in the field.

Further, the previous bonding agent did not always store well for extended periods of time in conditions of extreme temperature, exhibiting a tendency to settle. Extreme temperature fluctuations can cause stratification of the mixture.

Previous mixtures have also sometimes required the addition of a thickening agent to increase viscosity. These thickening agents are typically cellulose based and are thus vulnerable to bacterial attack.

It is an object of the present invention to overcome or ameliorate one or more of the disadvantages of the prior art, or to provide a commercial alternative.

### DESCRIPTION OF THE INVENTION

According to a first aspect, the invention provides a thermally stable composition for use in the manufacture of a lightweight aggregate including:

a continuous bituminous phase;

a discontinuous aqueous phase

an anionic oxide suspended in the discontinuous aqueous phase, and

at least one emulsifying agent.

Preferably, the anionic oxide is a naturally occurring metal oxide, for example red oxide, such as Cupric Oxide (CuO). It is highly preferred to use metal oxides having a needle like crystal structure. However, other naturally occurring oxides, for instance yellow oxide, may be used.

The discontinuous aqueous phase is preferably distilled, or deionized, water.

Grade 170 Bitumeni is preferred as the continuous bituminous phase, although other crude oil or hydrocarbons or mixtures thereof may be used.

The emulsifying agent is preferably a clay emulsifier, such as the sodium bentonites, hydrous aluminium silicose clays and montmorillonite families. A highly preferred emulsifier is Volclay® premium gel, which is a 200 mesh bentonite. Other gels having a similar structure, i.e. with an oleophilic tail and an oleophobic head have also been found suitable for use in the present invention.

Preferably, the composition further includes one or more of a thickener, an inhibitor, and a perfume. The selection of concentrated fragrance used does not appear to be critical. In the present invention, the preferred fragrance is “Eternal”. Similarly, the biocidal concentrate used does not appear to be critical, but sodium ortho-phenylphenol (“opp”) is preferred.

According to a second aspect, the invention provides lightweight aggregate particles coated with a composition according to the first aspect.

Although the coating composition can be applied to a wide range of light weight aggregate materials, it is preferred to apply the composition to polymer foam (including recycled polymer foam) particles, and it is especially desirable to select polystyrene foam particles as the lightweight aggregate to be coated.

According to a third aspect, the invention provides a building material formed from a lightweight aggregate according to the second aspect in combination with a cementitious material.

According to a fourth aspect, the present invention provides a method of forming a composition according to the first aspect, including the steps of:

optionally blending one or more of an air entrainment agent, a fragrance and a biocide with water and shearing to form a soap;

adding an emulsifier;

dispersing naturally occurring anionic oxide particles in the aqueous phase; and

dispersing the aqueous phase in a bituminous phase.

The present invention will now be described by way of example only with reference to the embodiments shown in the accompanying drawings and/or examples.

### BRIEF DESCRIPTION OF THE DRAWINGS

FIG. 1 shows a flow chart of a preferred method of forming the coating composition of the present invention

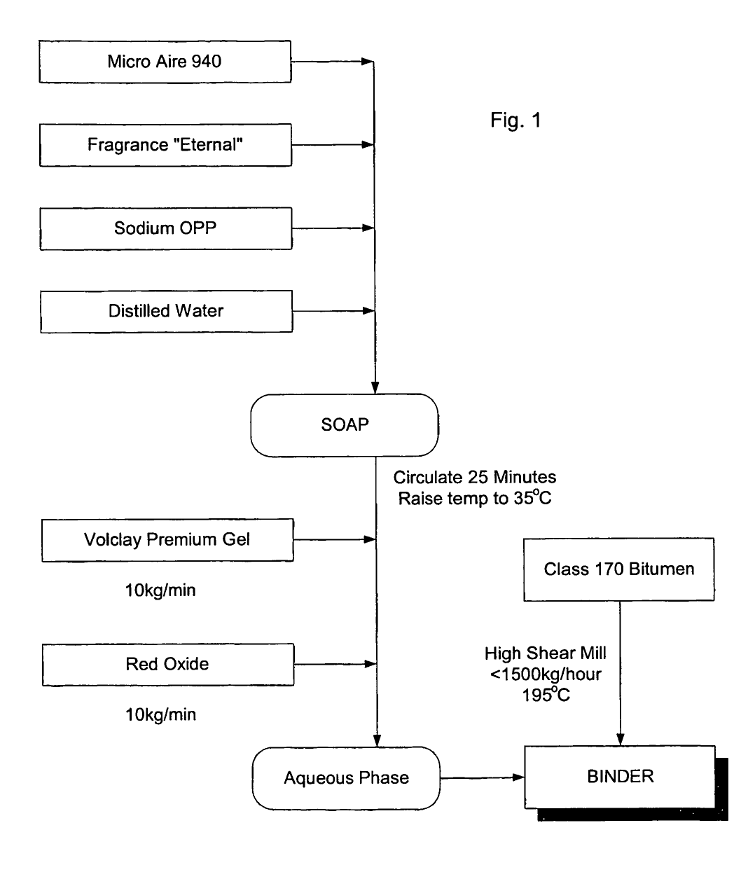

### BEST MODES FOR CARRYING OUT THE INVENTION

### EXAMPLE 1

### Bonding Agent

The preferred bonding agent of the present invention has the following composition (all values are wt %):

| Distilled water | 40% (wt %) |
|---|---|
| Bentonite (Volclay ® premium gel) | 5% |
| Red Oxide | 20% |
| Grade 170 Bitumen | 35% |
| sodium ortho-phenylphenol | .13% |
| Fragrance | .14% |
| Surfactant | .25% |

Compatible chemicals performing a similar function may be substituted for any of those exemplified in the above formulation, and the relative quantities adjusted accordingly in a manner which will be apparent to a skilled formulator based on the teachings hereof.

### EXAMPLE 2

### Preparation of Bonding Agent

The binder formulations of the present invention are best formed by an “in line” emulsification procedure according to the following steps:

1. Micro-aire 940, an air entrainment agent; “Eternal”, the desired fragrance; and sodium ortho-phenylphenol, an antibacterial agent (“opp”) are added to distilled water to form a soap. This soap is circulated for 25 minutes while the temperature is raised to 35° C.

2. Volclay® premium gel is then added to the soap at a slow rate, approximately 10 kg per minute.

3. Red oxide is then dispersed in the mixture at a rate of around 10 kg per minute

4. The mixture is sheared in a high shear mill while Grade170 Bitumen at 195° C. is added at around 1500 kg per hour.

In the above method, the exact sequence of addition in the manufacture of the composition is critical for obtaining the water-in-oil emulsion structure and for providing the coating composition with its useful properties. However, those skilled in the art of emulsification will appreciate that the conditions will vary with equipment employed and formulation used and that other methods for producing the water-in-oil emulsion with a dispersed aqueous phase containing the oxide in suspension may be suitable.

### EXAMPLE 3

### Physical Structure of Emulsion

The preferred physical structure of the natural anionic oxides preferred in the present invention may be classified as either “needle-like” or “spherical”. “Needle-like” oxides hold more water, so when they are formed into a paste, this tends to be drier, and thus more viscous than that formed from the corresponding “spherical oxide”. Needle-like oxides are highly preferred. However, the oxides may be either “needle-like” or “spherical”.

The droplets in the emulsion of the present invention have been found to be around 25 microns in diameter, which is considerably larger than the 5 micron diameter droplets found in typical emulsions, and contain the oxide as a suspension within the droplets.

### EXAMPLE 4

### Stability of Composition

The emulsion has been tested for prolonged exposure to freezing. No noticeable deterioration of the structure or qualities of the composition was observed.

### EXAMPLE 5

### Preparing Coated Aggregate

The coating composition (1 part by weight) is mixed with water (8 parts by weight). The formulation can then be used to coat polystyrene balls in a manner similar to that described in AU670754. The coated balls are free flowing when dry and have a pink appearance.

### EXAMPLE 6

### Concrete Preparation

The coated polystyrene balls form an aggregate which is mixed with cement, sand and water. Other types of conventional aggregate can be added if required.

The concrete produced using the present invention can be worked in the same way as normal concrete. The exact quantities used will depend upon the required properties of the concrete and the nature of the other materials used.

### EXAMPLE 7

### Concrete Produced

The concrete produced is compatible with the lightweight concrete described in AU670754 in terms of physical performance. The weight and other physical properties of the concrete produced in accordance with the present invention is similar to that described in AU670754. However, surprisingly, a compressive strength of around 30 MPa may be obtained using aggregate coated with bonding formulations of the present invention, which is unexpectedly 20% higher than that obtainable from the concrete of AU670754. Those skilled in the art will appreciate that lightweight concrete is designed for low load bearing applications.

Concrete weights as low as 250 kg/m³ can be obtained, but to achieve the maximum strength, 1200-1800 kg/m³ are used, which is about 50-75% the weight of conventional concrete. Concrete density may be controlled by varying the amount of polystyrene in the mixture.

The concrete also has the desirable insulation properties of the lightweight concrete in AU670754, namely a thermal insulation coefficient of 0.065 w/m degree C., and R up to 1.9. The sound insulation properties are also as for the concrete in AU670754, with an STC rating of 40-55.

Although the invention has been described with reference to a specific example, it will be appreciated by those skilled in the art that the compositions and methods of manufacture may be varied without departing from the inventive concept herein disclosed and that the invention may be embodied in many other forms.

1: A thermally stable composition for use in the manufacture of a lightweight aggregate including:
a continuous bituminous phase;
a discontinuous aqueous phase;
an anionic oxide suspended in the discontinuous aqueous phase; and
at least one emulsifying agent.

2: A thermally stable composition according to claim 1 wherein the anionic oxide is a naturally occurring metal oxide.

3: A thermally stable composition according to claim 1 wherein the anionic oxide is a metal oxide having a needle-like crystal structure.

4: A thermally stable composition according to claim 1 wherein the anionic oxide is red oxide (CuO) or yellow oxide.

5: A thermally stable composition according to claim 1 wherein the anionic oxide is present in an amount of 20 wt % of the composition.

6: A thermally stable composition according to claim 1 wherein the discontinuous aqueous phase is distilled and/or de-ionised water.

7: A thermally stable composition according to claim 1 wherein the discontinuous aqueous phase is water present in an amount of 40 wt % of the composition.

8: A thermally stable composition according to claim 1 wherein the continuous bituminous phase is grade 170 bitumen.

9: A thermally stable composition according to claim 1 wherein the continuous bituminous phase is selected from crude oil, hydrocarbons or mixtures thereof.

10: A thermally stable composition according to claim 1 wherein the continuous bituminous phase is present in an amount of 35 wt % of the composition.

11: A thermally stable composition according to claim 1 wherein the emulsifying agent is a clay emulsifier.

12: A thermally stable composition according to claim 8 wherein the clay emulsifier is selected from sodium bentonites, hydrous aluminum silicose clays, montmorillonite clays, and mixtures thereon.

13: A thermally stable composition according to claim 11 wherein the clay emulsifier is a 200 mesh bentonite.

14: A thermally stable composition according to claim 1 wherein the emulsifying agent is present in an amount of 5 wt % of the composition.

15: A thermally stable composition according to claim 1 wherein the emulsifying agent is a gel having an oleophilic tale and an oleophobic head.

16: A thermally stable composition according to claim 1 further including one or more of a thickener, a biocidal inhibitor, and a perfume.

17: A thermally stable composition according to claim 16 wherein the biocidal inhibitor is sodium ortho-phenylphenol.

18: Lightweight aggregate particles coated with a composition according to claim 1.

19: Lightweight aggregate particles according to claim 18 formed from polymer foam.

20: Lightweight aggregate particles according to claim 18 formed from polystyrene foam particles.

21: A building material formed from a lightweight aggregate according to claim 18 in combination with a cementitious material.

22: A method of forming a composition according to claim 1 including the steps of optionally bending one or more of an air entrainment agent, a fragrance and a biocide with water and shearing to form a soap;
adding an emulsifier;
dispersing naturally occurring anionic oxide particles in the aqueous phase; and
dispersing the aqueous phase in a bituminous phase.
